(19) United States
(12) Patent Application Publication
(10) Pub. No.: US 2023/0150838 A1
(43) Pub. Date: May 18, 2023

(54) SOLAR POWERED DESALINATION WITH DIRECT HEAT TRANSFER

(71) Applicant: Pitaya Yangpichit, Bangkok (TH)

(72) Inventor: Pitaya Yangpichit, Bangkok (TH)

(21) Appl. No.: 17/529,373

(22) Filed: Nov. 18, 2021

(51) Int. Cl. C02F 1/26; C02F 1/14; C02F 1/04

(52) U.S. Cl. CPC C02F 1/265; C02F 1/14; C02F 1/042; C02F 2103/08

(57) ABSTRACT

A solar-powered distillation process converts saline water into potable water and useful solid residues. A solid material is heated by solar energy, and the solid material is brought into direct contact with saline water. Some of the water becomes steam and vapor, which can be condensed to produce potable water. The water-soluble salts within the saline water are precipitated separately, and collected for commercial use. Scale formed on the solid material can be removed, and the solid material reheated by solar energy, and the reheated solid material can again be used to heat incoming saline water in a continuous process.

### BACKGROUND OF THE INVENTION

This invention relates to the production of potable water by the desalination of saline water. In general, the potable water shortage is becoming more and more acute. Conflicts over potable water are already taking place with increasing frequency. There are continuous efforts to convert more sea or saline water into potable water.

The two common desalination technologies of importance are SWRO (Sea Water Reverse Osmosis) and thermal distillation.

In SWRO, sea water is pumped at high pressure through a water permeable membrane. Water, the product, permeates through the membrane. Soluble salt content in the sea water is retained by the membrane, and the amount of salt in the membrane increases over time. The salt must be discarded when its concentration reaches a high level, typically between 20-50% of the feed water. The entire process is very energy intensive.

Thermal distillation is another process widely employed to produce potable water. The process, as the name implies, consists of boiling sea water, and condensing the vapor (steam) to produce potable water. When water is boiled off, soluble salts are left behind in the remaining seawater. The solution becomes more and more concentrated with salt, which then has to be discarded to prevent damage to the equipment. Typically, around 20% of the feed is used, whereas the balance of around 80% has to be discarded. The process is very energy intensive.

These two commercially significant processes require enormous amounts of energy of either fossil fuels or fossil fuel derived energy. In addition, waste disposal is a significant drawback. Both processes produce very large amounts of waste, i.e., highly saline water that must be discarded. Treating this waste is difficult and expensive. Ocean disposal causes damage to the marine environment.

In a conventional heating process used in distillation, the heat is transferred between two media which are separated by a barrier between them. The barrier, usually a metal or a material such as graphite, enables the heat transfer but prevents the mixing of fluids from opposite sides of the barrier. The present invention eliminates the need for such barrier.

### SUMMARY OF THE INVENTION

The present invention provides a method and apparatus for desalination of water, using a distillation process which is powered by solar energy. In the present invention, a solid material is heated by solar means, and the solid material heats the saline liquid by direct contact. Thus, the present invention eliminates the use of any barrier between the heated solid material and the liquid to be heated.

The hot solid material is introduced at the top of a chamber or tower and sinks to the bottom, transferring heat to the saline liquid which is pumped upward in the chamber. The solid material is preferably an impervious material such as silicon carbide, quartz, graphite, ceramics etc.

The saline water is heated and evaporates. The water vapor is then guided through pipes and heat exchangers to a barometric condenser. The vacuum created by the barometric condenser not only condenses the vapor, thereby producing water as a product, but also creates the condition in the equipment for the efficient removal and recovery of remaining salts in the saline water.

After having been used to heat the water, the solid material is extracted, renovated, and recycled to continue the process.

The retrograde salts, calcium carbonate and calcium sulfate, precipitate due to a high saline temperature, and are removed by a desludging unit. The halides NaCl and MgCl₂ undergo crystallization and finally precipitate in two separate chambers where they can be removed as solidified salts. Therefore, the process is a ZLD (Zero Liquid Discharge) process as there is virtually no liquid discharge at all.

The present invention therefore comprises an efficient and economical process which combines barrier free solar heating and vacuum cooling, while eliminating or substantially mitigating the disadvantages discussed above.

The present invention therefore has the primary object of providing a desalination process which is powered by solar energy.

The invention has the further object of providing a desalination process which uses thermal distillation, and in which saline water is heated by direct contact with a hot solid material.

The invention has the further object of providing an efficient process for desalination, while also producing commercially useful residues from the saline water being treated.

The invention has the further object of producing potable water, and other products of commercial use, while generating a minimum of waste, and while minimizing the overall costs of maintenance and energy.

The invention has the further object of providing an apparatus which performs the above-described functions.

The reader skilled in the art will recognize other objects and advantages of the invention, from a reading of the following brief description of the drawings, the detailed description of the invention, and the appended claims.

### BRIEF DESCRIPTION OF THE DRAWINGS

FIG. 1 provides a schematic diagram of an apparatus made according to the present invention.

FIG. 2 provides a schematic diagram of the circulation devices, and associated components, used in the present invention, the circulation devices being identified as CD1 and CD2 in FIG. 1.

FIG. 3 provides a schematic diagram of the solar heaters used in a preferred embodiment of the present invention, the solar heaters being identified schematically as SH1 and SH2 in FIG. 1.

FIG. 4 provides a schematic diagram of various parts of the apparatus of the present invention, showing a chamber into which heated solid material is introduced at its top, and saline liquid is introduced at its bottom, and showing the renovation, reheating, and recycling of solid material used to heat incoming saline water.

FIG. 5A provides an elevational view of a chamber or tower, made according to the present invention, and used for providing direct contact between heated solid material and a liquid to be desalinated.

FIG. 5B provides a top view of the chamber of FIG. 5A.

FIG. 6 provides a schematic, elevational view of an alternative embodiment in which the chamber includes baffle plates instead of a helical structure.

### DETAILED DESCRIPTION OF THE INVENTION

In brief, the process of the present invention is as follows. First, solid material (preferably having the form of a plurality of small solid balls) is heated by solar means, outside a vessel or chamber. The heated balls are introduced into the vessel, at or near its top or upper region, while saline liquid is pumped upward within the vessel. The balls fall by gravity through the vessel, while continuously contacting the liquid. The balls heat the liquid so as to cause the liquid to vaporize, thus separating the liquid from the salts carried by the liquid. In this way, the process produces potable water and one or more solid residues which can be commercially useful. The solid balls are recovered from the bottom or lower region of the vessel, and are renovated and then reheated and reintroduced into the vessel without interrupting the process.

The term “renovated”, as used in this specification, means the removal of scale deposits which form on the surfaces of the solid material, as a consequence of the contact between the hot solid material and the saline liquid.

Scales form when soluble salts extracted from saline liquid become deposited on warm surfaces. Such scale formation interferes with heat transfer surfaces, thus reducing the efficiency of heat transfer.

It is expensive and difficult, and time consuming, to remove the scales directly. In the prior art, it has been necessary to shut down the process to remove the scales. In the present invention, scale formed on the surfaces of the solid balls is removed by abrasion created when the balls impact each other, and when they impact the surfaces on which they travel.

In the present invention, the hot surface is provided by the heated solid balls, which are continuously moving through the liquid, and which are continuously removed, renovated, reheated, and re-used. By keeping the solid material in a continuous state of motion, and by renovating the solid material by abrasion, the present invention avoids the problem of scale formation, and the process can be operated continuously, without disruption.

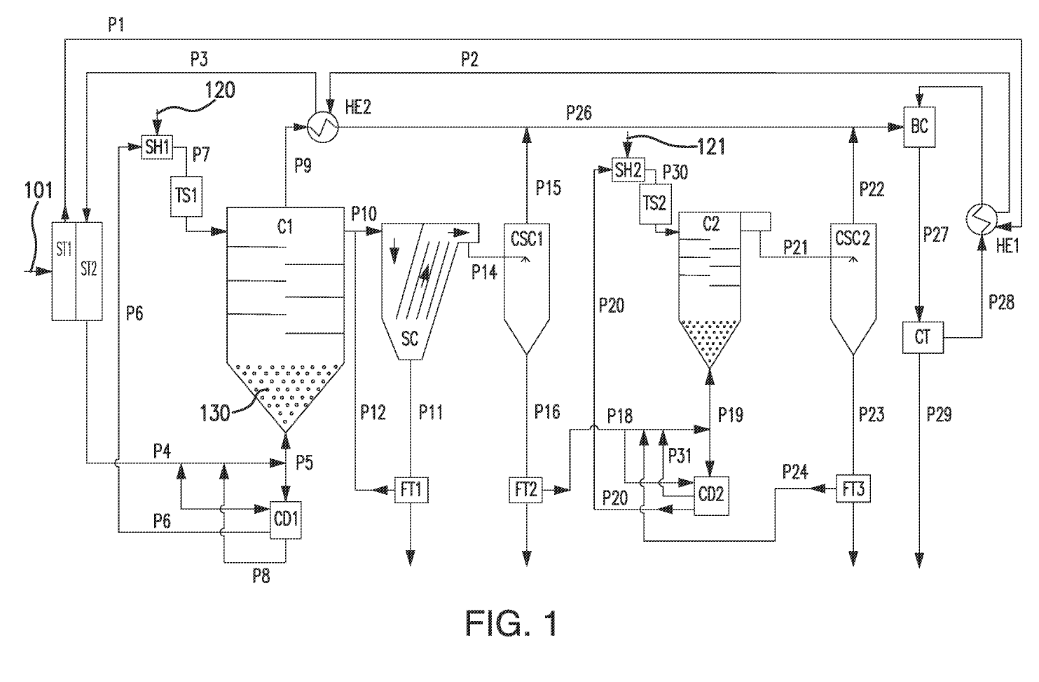

The detailed structure and operation of the apparatus of the present invention will first be described with reference to the schematic diagram of FIG. 1. Then, further details of the major components will be described with respect to the other figures.

In this specification, the terms “solid material” and “solid balls” will be used interchangeably, it being understood that a preferred form of solid material is that of solid balls. However, the invention is not limited to use with solids in the form of balls or spheres.

As shown in FIG. 1, cool and filtered raw saline water enters storage tank ST1, through a conduit represented by arrow 101. The liquid is kept at a sufficient volume to allow a preferably constant flow of the saline which will enter the desalination process through pipe P1.

The saline water leaves the storage tank ST1 via pipe P1, and flows towards heat exchanger HE1. In this heat exchanger, the saline liquid is preheated by heat exchange with circulating hot potable water.

The now preheated saline water then flows through pipe P2, and is further heated in heat exchanger HE2, which receives heat from vapor or steam created in chamber C1, as will be explained below. The water passing through heat exchanger HE2 then flows through pipe P3, into the raw saline storage tank ST2.

From the storage tank ST2, a now warm saline flows further through pipe P4, into pipe P5, and then upwards into chamber C1. The chamber is preferably insulated. It is in this chamber that the saline liquid is placed in continuous contact with heated solid material, so that heat is transferred from the solid material to the liquid. The solid material preferably has the form of small balls or spheres, indicated symbolically by reference numeral 130. The solid material flows countercurrently relative to the inflow of the saline liquid. That is, in chamber C1, the liquid flows upwardly, and the solid material flows downwardly.

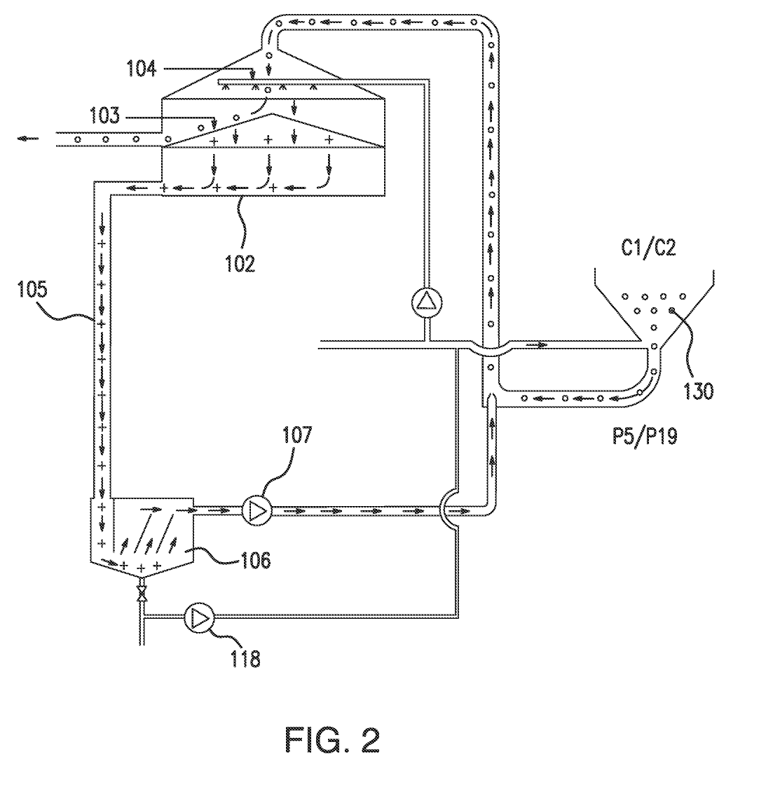

The solid material exits the chamber at the bottom, through pipe P5, and flows into a circulation device CD1, which is more fully illustrated in FIG. 2, and which will be described later. The circulation device recirculates the solid material through pipe P6. Also, some of the saline liquid is recycled through pipe P8.

Chamber C2, which will also be described later, is similar in construction to that of chamber C1. Solid material flows out of chamber C2 through pipe P19 and into circulation device CD2, also illustrated more fully in FIG. 2, and which will be described later.

Pipe P5, at the bottom of chamber C1, is similar to pipe P19, at the bottom of chamber C2. Similarly, pipe P8 corresponds to pipe P31, and pipe P6 corresponds to pipe P20. Also, pipe P4 corresponds to pipe P18.

In the case of both chambers C1 and C2, the solid material leaving the chambers, at the bottoms thereof, is renovated and reheated. The details of the renovation and reheating will be described later. For present purposes, it should be understood that the solid material is conveyed to solar heaters SH1 and SH2. These solar heaters receive solar radiation, symbolized by arrows 120 and 121. The heated material is conveyed, through pipes P7 and P30, respectively, into temporary heated storage units TS1 and TS2, before re-entering the upper regions of the respective chambers C1 and C2.

The preferably continuous flow of warm saline into the chamber C1 at its bottom will cause an overflow of saline at its top which then flows through pipe P10 into sludge chamber SC. A minor amount of the saline leaves the sludge chamber at its bottom through pipe P11, and is filtered in the filtration tank FT1 and circulated back into the sludge chamber by pipes P12 and P10. The majority of the saline runs by overflow through pipe P14 into the crystallization spray chamber CSC1.

Inside the sludge chamber SC, retrograde salts such as calcium sulfate and calcium carbonate will precipitate and accumulate. These materials accumulate in the sludge chamber, and are funnelled into pipe P11, then filtered inside filtration tank FT1, and then withdrawn from the process as a product having commercial value.

The remaining filtered saline is pumped back into the sludge chamber SC through pipe P12. The saline enters pipe P10, preferably at the top of the sludge chamber. The continuous overflow of saline in the sludge chamber SC flows into pipe P14 and is released as a spray inside the crystallization spray chamber CSC1, in which the halide sodium chloride is crystallized, preferably under vacuum, and funneled into pipe P16, where it is filtered in filtration tank FT2 and subsequently withdrawn from the process as another product having commercial value.

In the crystallization spray chamber CSC1, the majority of the liquid saline is vaporized, leaving the crystallization chamber CSC1 by pipe P15. A small part of the liquid is drained into the filtration tank FT2, and then fed into pipe P18 and finally pipe P19.

The continuous flow of saline into chamber C2, through pipes P18 and P19, causes an overflow of saline guided by pipe P21 into crystallization spray chamber CSC2, where it is sprayed downwardly, releasing its heat as steam or vapor upwardly into pipe P22 and subsequently pipe P26. The remaining liquid flows through pipe P23, and is filtered to remove the halide magnesium chloride, in filtration tank FT3, and the residue is recovered as a product of commercial value. The remaining saline is pumped back through pipe P24, entering pipe P18, and then flows into pipe P19, so as to be able to return to chamber C2.

The saline which passes filtration tank FT2 is pumped through pipe P18 into pipe P19, which connects chamber C2 with circulation device CD2. The saline flows upwardly, through pipe P19, in the opposite direction to the solid material, and the saline is heated by direct contact with the solar heated solid material flowing downwardly, as was described with respect to chamber C1. The solid material finally drops through pipe P19 into the circulation device CD2, to be described in detail later, from which it is recirculated by pipe P20 into solar heater system SH2, and finally introduced, via solid storage TS2, into the chamber C2 again, from the upper region, thus continuously reheating the saline liquid inside the chamber.

A final circulation of pure potable water takes place at the barometric condenser BC. This barometric condenser creates a vacuum and condenses the incoming steam/vapor from the desalination process to be collected as the end product. The circulating potable water is pumped from the water circulation tank CT via pipe P28 to the heat exchanger HE1 and the barometric condenser BC, and back into the water circulation tank CT. The excess of condensed steam/vapor is finally collected as potable water through pipe P29.

During the desalination process, saline water will thus be split into three components, namely liquid, steam and/or vapor, and salts.

Stated in more detail, the steam leaving chamber C1, through pipe P9, the vapor leaving the crystallization spray chamber CSC1, through pipe P15, and the steam or vapor from the crystallization spray chamber CSC2, flowing through pipe P22, are condensed in the barometric condenser BC, to become potable water. The potable water flows through pipe P27, and enters a circulatory flow into a circulating tank CT, flowing through pipe P28 and passing through heat exchanger HE1, to release heat, and enters the barometric condenser again. The steady inflow of steam and vapor from pipe P26 being condensed by the barometric condenser causes an accumulation and finally an overflow of potable water inside the circulation tank CT which is then collected and withdrawn from the process as a product having commercial value. The potable water is collected through pipe P29.

In summary, in chamber C1, the warm raw saline enters the chamber at the bottom, flowing upwards and heated by contact with the solid material, which counterflows downwards through the chamber. The steam will leave the chamber C1 at the top, through pipe P9, passing through heat exchanger HE2, through pipe P26, and towards the barometric condenser BC.

A secondary flow of steam and/or vapor will exit the crystallization spray chamber CSC1, joining the steam flow from chamber C1, also towards the barometric condenser BC.

A third flow of steam/vapor exiting the crystallization spray chamber CSC2, will again join the previous two streams on their way to the barometric condenser BC.

The steam and/or vapor from each of the chamber C1, the crystallization spray chamber CSC1, and the crystallization spray chamber CSC2, are all accumulated in pipe P26. Inside the barometric condenser BC, the incoming steam/vapor is liquified and finally collected as warm, potable water.

FIG. 2 provides details of the fluid circuit which includes chambers C1 and C2, and which renovates the solid material. The components other than the chambers C1/C2 comprise the circulation devices identified by CD1 and CD2 in FIG. 1.

The solid material, typically having the form of solid balls 130, falls out of the chambers C1 and C2, and is conveyed to vibrating sieve 102. The balls are transported in saline liquid, which is moved through the system by liquid circulation pump 107. This means of transport has been found to be dust-free, efficient, and economical.

The solid balls fall onto a conical abrasive screen 103 within the vibrating sieve 102, and are shaken, rolled about, and abraded by the abrasive screen. In this way, the scale material, which has formed and accumulated on the surfaces of the balls, is removed.

The solid balls are then sprayed with saline liquid, by sprayer 104, so as to flush off the debris on the balls, before they roll down a chute (not shown) to begin the reheating process. The conveying saline, the flushing saline, the scale material, and the detritus all flow through the abrasive screen and collect at the bottom of the vibrating sieve, and then drain through the outlet pipe 105 into a settling tank 106 where the solids settle and are removed. The filtered saline returns to the process via pipe P4 and pipe P18 of FIG. 1. In FIG. 2, there is shown pump 118 which pumps the filtered saline back into the chamber. Pump 118 is therefore an illustration of a means for directing saline water upwards through the chamber. The vibrating sieve 102, and associated components, is a means for recovering and renovating the solid material.

Wet abrading is a fast, economical, environmentally friendly process for renovating or reconditioning the solid balls. The scale material and detritus are removed in solid form.

The solid balls may also be renovated or reconditioned by chemical, ultrasonic, or other means.

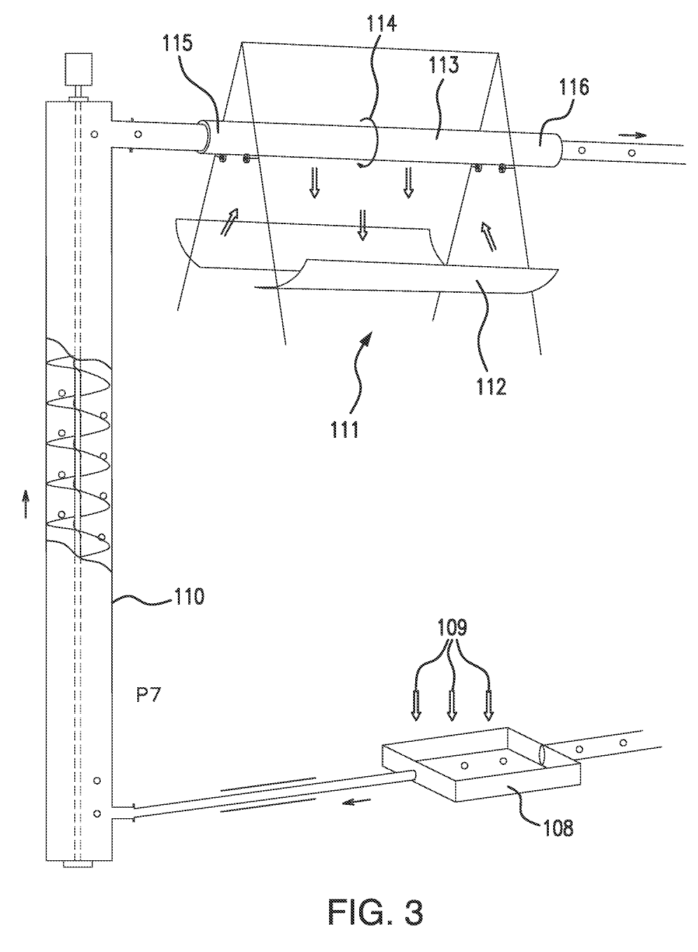

FIG. 3 provides a schematic diagram showing details of the solar heating of the solid material. FIG. 3 shows the preferred structure for either or both of solar heaters SH1 and SH2 of FIG. 1.

After the solid balls have been renovated, the balls are ready to be reheated, as represented by solar heaters SH1 and SH2 of FIG. 1.

As shown in FIG. 3, the solid balls are sent first to a flat plate heater 108, which allows the balls to be heated by solar radiation 109. While the flat plate heater is efficient, it is unable to achieve the high temperature necessary for efficient operation of the process.

The solid balls are therefore transported by a vertical screw conveyor 110 to a secondary heater 111, which comprises a line focus Fresnel reflector heater, where the balls are heated to a very high temperature. The line focus Fresnel reflector heater includes a quartz tube 113 located above an assembly of mirrors 112 which reflect solar radiation and concentrate it on the quartz tube. The quartz tube is supported by rollers and a drive mechanism (not shown) which rotates the tube around its axis, as indicated by arrow 114.

The secondary heater 111 is mounted at an incline. The inlet end 115 of the quartz tube 113 where the solid balls are fed is higher than the outlet end 116. The outlet end 116 is similarly higher than the inlet of temporary storage devices TS1 and TS2 of FIG. 1.

Solar radiation heats the solid balls inside the quartz tube. Rotating the quartz tube results in even heating of the solid balls, and facilitates moving the solid balls down the incline from the inlet towards the outlet of the secondary heater, and on to the inlet of the temporary storage devices TS1 and TS2 of FIG. 1.

One or both of heaters 108 and 111 can be considered a heating means in the present invention.

The solid balls could also be heated by a parabolic trough, or a flat or curved Fresnel lens concentrator. The quartz tubing can also be non-transparent, metallic, non-metallic such as graphite, for indirect heating of the solid balls.

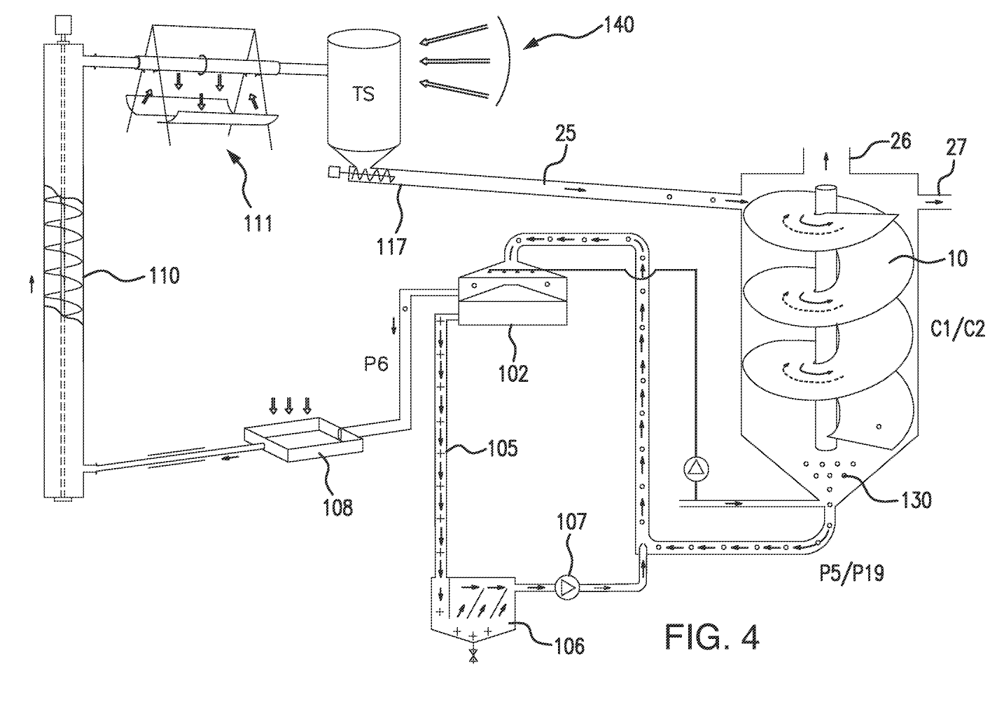

FIG. 4 provides details of the structure of the chambers C1 and C2, and shows these chambers as part of a closed loop which includes the renovation and heating devices associated with the respective chambers. Note that a single element C1/C2 is shown in FIG. 4, representing both of chambers C1 and C2.

The chambers C1 and C2 contain a vertical helix 10. As described with respect to FIG. 1, a temporary solid material storage tank TS stores the solid material before it is dispensed into the chamber. The solid material then rolls, by gravity, along chute 25, into the upper region of the chamber, where it will continue to travel, by gravity, while releasing its heat into the already pre-warmed saline liquid inside the chamber. The chute 25 can be considered a means for conveying the heated solid material into the chamber. The storage tank TS of FIG. 4 is intended to represent either of TS1 or TS2 of FIG. 1.

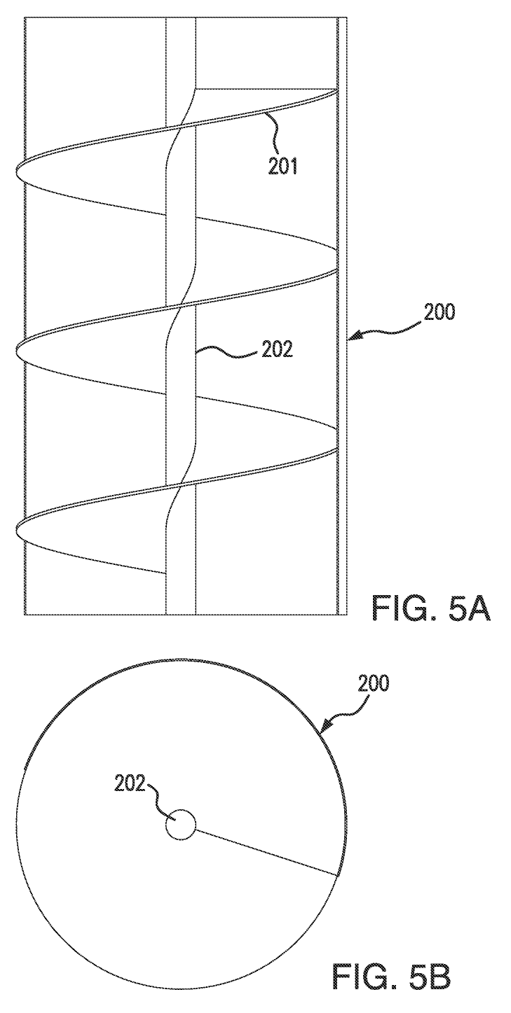

The inside of the chamber may be provided with suitable structures to prolong the contact time of the saline with the solid material. For example, as shown in FIG. 4, the helix 10 of the chamber comprises an internal plate having the form of a spiral, which is shown explicitly in FIGS. 4 and 5A. The solid material is forced to roll down the spiral plate, thereby prolonging contact with the saline. While rolling, the heat from the solid material is efficiently released by the turbulence induced by the movement of the solid material, due to the shape of the solids and their movement towards the bottom of the chamber.

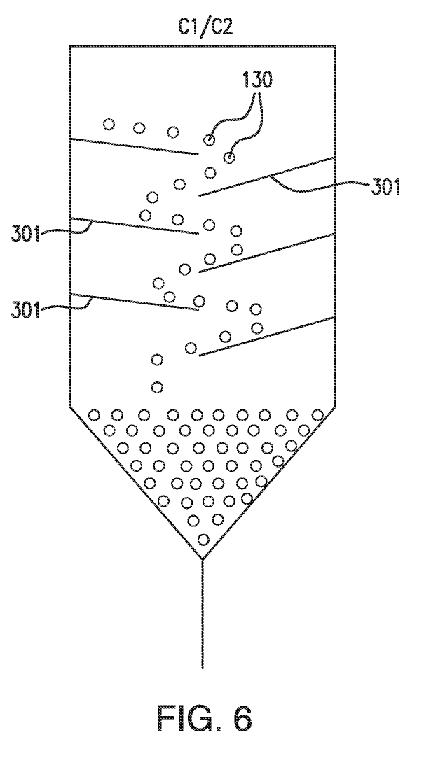

In an alternative embodiment, shown in FIG. 6, instead of a spiral or helical structure, the inside of the chamber C1 (or C2) has baffle plates 301, extending from either side of the chamber, and arranged to project alternately from one side and the other, so as to cause the balls 130 to fall along a generally zig-zag path.

The solid material leaves the chamber C1/C2 by either of pipes P5 or P19, into the circulation device CD1/CD2, shown in FIG. 4 and previously described with respect to FIG. 2. The circulation device drains off the saline at the top of the device before the solid material enters the solar heaters. The flat plate solar heater 108, the secondary solar heater 111, and the vertical screw conveyor 110 are the same as in FIG. 3.

As shown in FIG. 4, the hot solid material flows, by gravity, into storage tank TS. The storage tank TS could optionally be heated also, and could comprise a tertiary solar heater. This tertiary solar heater is designated generally by reference numeral 140 in FIG. 4. The drawing symbolically illustrates a solar concentrator and rays which converge on the storage tank. However, the storage tank TS could be heated instead by non-solar means.

The bottom of the temporary storage tank TS has a feed controller or dispenser 117 which can adjust the amount of solid material released from the temporary storage tank TS.

The solid material then enters chamber C1 or C2 through an inlet chute 25 at the upper side. The solid material storage facilities, the storage tank, and the storage dispenser are designed to store flexible amounts of solid hot material of desired shapes and/or size, to maintain the process heat capacity which is needed in times of insufficient solar radiation, such as on cloudy days, and during night, to ensure overall continuous production.

The highest temperature in chamber C1 or C2 will be at the top surface of the saline liquid inside the chamber, due to the heat exchange while in contact with the hot solid material entering the chamber. Some saline flashes off as steam, which leaves the chamber C1 through pipe P9, and passes through heat exchanger HE2, to heat further the fresh warm raw saline on its way to the storage tank ST2.

In FIG. 4, vapor leaves the chamber C1/C2 through port 26, located at the top. Hot liquid leaves the chamber through port 27, located at the upper right-hand side.

FIGS. 5A and 5B show the structure of either of the chambers C1 or C2. Chamber 200 comprises a generally cylindrical housing, in which there is disposed a vertical helix 201 which defines the spiral path for the solid balls described above. The vertical helix surrounds, and may be mounted to, a post 202. FIG. 5B provides a top view of the chamber 200.

All process equipment which has a higher or lower temperature than ambient is preferably insulated by suitable insulation materials which prevent heat or cooling losses during the process. The chambers and other equipment are preferably fabricated from thermo plastic and/or saline resistant material.

The solid material used in the present invention preferably is made of solid, round balls which are inert and thermally stable. It is preferred that the solid material have a density substantially greater than that of the saline liquid, to allow easy separation of the solid from the liquid.

Regardless of the shape of the solid material, it is preferable that the material be pourable. That is, the solid material preferably comprises a plurality of pieces each having a sufficiently small diameter that the material can be efficiently poured and/or moved through a pipe or conduit by a liquid. The use of a large number of relatively small pieces also has the advantage of maximizing the amount of surface contact between the solid and the saline liquid.

The solid material may be made of ceramic, such as aluminum oxide, graphite, silicon carbide, or quartz. The preferred diameter of the balls is about 5-25 mm. The balls are easily removed from the vessel, and can be easily renovated by causing rolling and/or vibratory motion.

The solid material could also be non-spherical, and could vary in size from the range described above. The solid could be an alloy, a eutectic liquid or solid, or a liquid such as mercury. The solid material could have a shape like that of a ball bearing. Also, the solid material could include combinations of materials having different compositions, and could include pieces of varying shape and/or size. All such combinations of compositions, shapes, and sizes are within the scope of the present invention.

The present invention also overcomes the problem of scale formation in heat exchangers used in the thermal evaporation of saline liquids.

The spiral upward flow of saline liquid minimizes the mixing between incoming and exiting liquid.

The conical bottom of the chamber allows easy collection, recovery, and transfer of the solid balls to the location where they can be reheated.

The final products of the desalination process include 1) potable water, collected at the circulation tank CT, 2) retrograde products calcium carbonate and calcium sulfate, collected at the filtration tank FT1, 3) the halide sodium chloride at filtration tank FT2, and 4) the halides magnesium and potassium salt at filtration tank FT3.

The invention can be modified in various ways. The number of chambers can be increased or decreased. Although a dual solar heater, as shown, is preferred, there could be as few as one solar heater, or there could be more than two such heaters. There also could be non-solar heat sources, in addition to the solar heaters.

In another embodiment, the storage tank for the hot solid material could be divided into sections, with extra solar heating being directed at one of such sections.

The modifications indicated above, and others which will be apparent to those skilled in the art, should be considered within the spirit and scope of the following claims.

What is claimed is:

1. A method of desalinating water by using solar energy, the method comprising the steps of:
a) heating a solid material using solar energy,
b) placing the heated solid material in direct contact with saline water, so as to vaporize at least a portion of the water, and
c) recovering and condensing at least some of said vaporized water.

2. The method of claim 1, wherein step (a) comprises selecting the solid material to have the form of a plurality of pieces such that the solid material is pourable.

3. The method of claim 2, further comprising renovating the solid material by abrading the solid material to remove scale formed thereon, reheating the renovated solid material using solar energy, and recycling the renovated and reheated solid material for use in heating incoming saline water.

4. The method of claim 2, wherein step (b) comprises introducing the solid material into a chamber, while directing saline liquid through the chamber in a direction opposite to that of the solid material, such that the solid material is in direct contact with the saline liquid.

5. The method of claim 1, wherein step (b) comprises conveying heated solid material into an upper region of a chamber, such that the solid material falls by gravity through the chamber, and directing saline water upward through the chamber, such that the solid material comes into direct contact with the saline water.

6. The method of claim 5, further comprising recovering and renovating the solid material, and repeating steps (a) and (b) using the recovered and renovated solid material.

7. The method of claim 5, wherein the renovating step comprises abrading the solid material such that scale formed on the solid material is removed.

8. The method of claim 5, wherein the chamber houses a plate having the form of a spiral, wherein the spiral plate defines a surface on which the solid material can fall by gravity while in contact with the saline liquid.

9. The method of claim 5, wherein the chamber houses a plurality of alternating baffles which define a zig-zag path for the solid material to fall by gravity while in contact with the saline liquid.

10. The method of claim 1, further comprising recovering solid residue after said portion of water has been vaporized.

11. The method of claim 10, wherein the step of recovering solid residue comprises directing heated saline into at least one crystallization spray chamber, in which a solid residue is crystallized under vacuum and filtered to produce a product having commercial value.

12. Apparatus for desalination of water by solar heating, the apparatus comprising:
a) means for heating a pourable solid material by solar energy,
b) means for conveying material from the heating means into an upper region of a chamber, such that the solid material falls by gravity through the chamber,
c) means for directing saline water upward through the chamber, such that the solid material comes into direct contact with the saline water and transfers heat to the saline water, so as to separate the saline water into potable water and solid residue,
d) means for recovering and renovating the solid material, and for returning renovated solid material to the heating means.

13. The apparatus of claim 12, wherein the renovating means includes a vibrating sieve and an abrasive screen, such that the solid material can be abraded to remove scale formed on the solid material.

14. The apparatus of claim 12, wherein the chamber houses a plate having the form of a spiral, wherein the spiral plate defines a surface on which the solid material can fall by gravity while in contact with the saline liquid.

15. The apparatus of claim 12, wherein the chamber houses a plurality of alternating baffles which define a zig-zag path for the solid material to fall by gravity while in contact with the saline liquid.

16. The apparatus of claim 12, wherein the heating means is connected to a temporary storage unit for holding heated solid material, the temporary storage unit being connected, via a chute, to the chamber, wherein heated solid material can pass through the chute and into the chamber.

17. Apparatus for desalination of water by solar heating, the apparatus comprising:
a) a chamber in which there is disposed a generally spiral surface on which a solid material can travel by gravity from an upper region to a lower region of the chamber,
b) means for directing saline water upward through the chamber, such that the saline water and heated solid material come into direct contact,
c) means for collecting solid material from the bottom region of the chamber, and for renovating the solid material by abrading it to remove scale formed on the solid material,
d) means for conveying renovated solid material to at least one solar heater, wherein the solid material is heated by solar energy, and
e) means for conveying the heated solid material to the upper region of the chamber,
wherein the chamber includes an opening which allows vapor or steam formed by heating of the saline water to leave the chamber, and wherein the apparatus includes means for condensing the vapor or steam to produce potable water.

18. The apparatus of claim 17, wherein the directing means comprises a pump which forces the saline water upward through the chamber.

19. The apparatus of claim 17, wherein the renovating means comprises a vibrating sieve which causes pieces of the solid material to impact each other, and to impact a surface on which the pieces travel, thereby abrading the pieces of solid material and removing scale therefrom.
